(19) United States
(12) Patent Application Publication
(10) Pub. No.: US 2025/0080166 A1
(43) Pub. Date: Mar. 6, 2025

(54) WIRELESS COMMUNICATION APPARATUS, WIRELESS COMMUNICATION SYSTEM, AND CONTROL METHOD

(71) Applicant: CANON KABUSHIKI KAISHA, Tokyo (JP)

(72) Inventor: TAKAYA NISHIZAWA, Kanagawa (JP)

(21) Appl. No.: 18/818,171

(22) Filed: Aug. 28, 2024

(30) Foreign Application Priority Data
Aug. 29, 2023 (JP) 2023-138935

(51) Int. Cl. H04B 5/26; H01P 3/08; H04B 5/43; H04B 5/72

(52) U.S. Cl. CPC H04B 5/26; H01P 3/08; H04B 5/43; H04B 5/72

(57) ABSTRACT

A wireless communication apparatus for performing wireless communication, through an electromagnetic field coupling, with another wireless communication apparatus, includes at least one communication transmission line comprising a first transmission line formed of a conductor disposed in a circular arc form, and a second transmission line formed of a conductor disposed radially inside the first transmission line and coaxially with the first transmission line, the second transmission line being in a shape along a circular arc shorter than the first transmission line, and a communication unit configured to be connected to the first transmission line and the second transmission line and configured to transmit signals to the first transmission line and the second transmission line or receive signals from the first transmission line and the second transmission line. At least a part of the second transmission line is formed in a meander shape.

### BACKGROUND

### Field

The present disclosure relates to a wireless communication apparatus for performing wireless communication through an electromagnetic field coupling, a wireless communication system, and a control method.

### Description of the Related Art

Some recent systems perform communications through rotatable portions, such as a pan head used for a robotic hand joint or a network camera. Wireless communication via such a rotatable portion enables infinite rotation, and eliminates wiring disconnection risks, providing improved maintainability as an advantage. For example, with the increase in the performance of network cameras, the amount of data transmitted via rotatable portions is increasing year by year. Accordingly, there has been a demand for higher wireless data transmission speed also in wireless communications.

For example, Japanese Patent No. 06304906 discloses a wireless communication apparatus allowing performing non-contact data transmission through an electromagnetic field coupling between the differential transmission lines circularly disposed for the rotatable portion and the coupler.

### SUMMARY

According to one embodiments of the present disclosure, a wireless communication apparatus for performing wireless communication, through an electromagnetic field coupling, with another wireless communication apparatus, includes at least one communication transmission line comprising a first transmission line formed of a conductor disposed in a circular arc form, and a second transmission line formed of a conductor disposed radially inside the first transmission line and coaxially with the first transmission line, the second transmission line being in a shape along a circular arc shorter than the first transmission line, and a communication unit configured to be connected to the first transmission line and the second transmission line and configured to transmit signals to the first transmission line and the second transmission line or receive signals from the first transmission line and the second transmission line. At least a part of the second transmission line is formed in a meander shape.

Further features of the present disclosure will become apparent from the following description of exemplary embodiments with reference to the attached drawings.

### BRIEF DESCRIPTION OF THE DRAWINGS

FIG. 1 illustrates a schematic configuration example of a wireless communication system according to a first exemplary embodiment.

FIG. 2 illustrates a schematic configuration example of a conventional wireless communication system.

FIGS. 3A to 3C are timing charts illustrating signals at different positions of communication transmission lines having conventional shapes.

FIGS. 4A to 4C are timing charts illustrating signals at different positions of communication transmission lines according to the first exemplary embodiment.

FIG. 5A is a perspective view illustrating a structural example of the communication transmission lines according to the first exemplary embodiment.

FIG. 5B is a plan view illustrating the structural example of the communication transmission lines according to the first exemplary embodiment.

FIG. 5C is a cross-sectional view taken along the C-C line of FIG. 5B.

FIGS. 6A and 6B illustrate signal transfer characteristics of a communication transmission line illustrated in FIGS. 5A to 5C.

FIGS. 7A, 7B, and 7C illustrate signal phase characteristics of a communication transmission line illustrated in FIGS. 5A to 5C.

FIGS. 8A and 8B illustrate phase differences of signals transmitted from the communication transmission lines illustrated in FIGS. 5A to 5C to a coupler.

FIGS. 9A and 9B illustrate the signal transfer characteristics with design values at points with different magnitudes of phase difference.

FIG. 10 illustrates a schematic configuration example of a wireless communication system according to a second exemplary embodiment.

FIG. 11 illustrates a schematic configuration example of a wireless communication system according to a third exemplary embodiment.

FIG. 12 illustrates a schematic configuration example of a wireless communication system according to a fourth exemplary embodiment.

FIG. 13 illustrates another schematic configuration example of a wireless communication system according to the fourth exemplary embodiment.

### DESCRIPTION OF THE EMBODIMENTS

Exemplary embodiments of the present disclosure will be described with reference to the accompanying drawings.

The following exemplary embodiments are merely examples for realizing the present invention, and can be corrected or modified depending on the configuration of an apparatus according to the present disclosure and other various conditions without departing from the spirit of the present invention. The present invention is not limited to the following exemplary embodiments.

In the following descriptions of the drawings, identical or similar portions are assigned identical or similar reference numerals. However, the drawings are schematically drawn, so that it should be noted that the length and width dimensions and scales of members and portions are different from actual ones. Specific dimensions and scales should be determined taking into consideration the following descriptions. The drawings also include portions with a dimensional relationship and ratios different from those in other drawings.

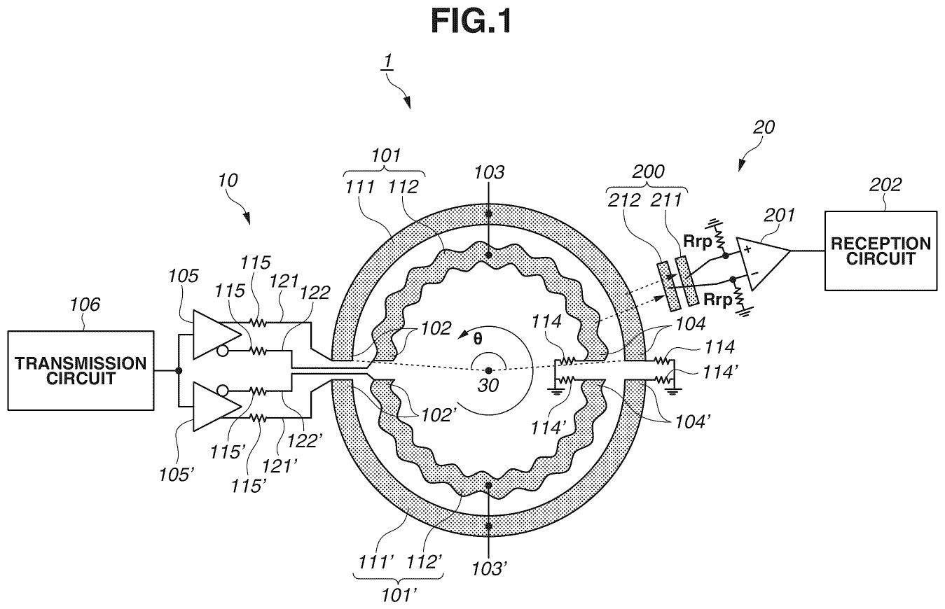

A first exemplary embodiment of the present disclosure will be described. FIGS. 1 to 9A and 9B illustrate the first exemplary embodiment.

FIG. 1 illustrates a schematic configuration example of a wireless communication system 1 according to the first exemplary embodiment.

As illustrated in FIG. 1, the wireless communication system 1 includes wireless communication apparatuses 10 and 20.

The wireless communication apparatuses 10 and 20 are configured to wirelessly communicate with each other through an electromagnetic field coupling. The term “an electromagnetic field coupling” refers to a coupling by an electric field, a coupling by a magnetic field, and a coupling by an electric and magnetic field.

### [Configuration of Wireless Communication Apparatus 10]

A configuration of the wireless communication apparatus 10 will be described.

The wireless communication apparatus 10 includes communication transmission lines 101 and 101′ each consisting of differential transmission lines, differential amplifier circuits 105 and 105′, and a transmission circuit 106.

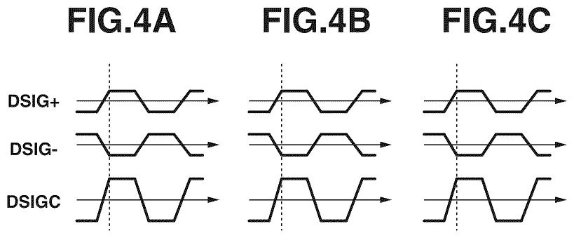

Each of the communication transmission lines 101 and 101′ is disposed on a dielectric substrate 400, for example, with a view to achieving a low height (thin) (see FIGS. 4A to 4C).

The communication transmission line 101 includes a transmission line 111 disposed in a circular arc form about a rotation axis center 30, and a transmission line 112 disposed radially inside the transmission line 111 and coaxially with the transmission line 111. The two transmission lines are disposed in shapes along circular arcs having a common center angle θ. Each of the transmission lines 111 and 112 is made of a conductor.

One end of the transmission line 111 and one end of the transmission line 112 each include a power feeding portion 102 into which signals are input from the differential amplifier circuit 105.

The other terminal portions 104 of the transmission lines 111 and 112 each include a terminal portion 104 terminated with a termination resistor 114 having an impedance substantially the same as the characteristic impedance of the corresponding transmission line of the transmission lines 111 and 112.

The communication transmission line 101′ is assigned the same reference numeral (number) as that to the communication transmission line 101 with a trailing dash (′). Components assigned a number have similar configurations, and redundant descriptions thereof will be omitted.

The transmission circuit 106 outputs a signal (hereinafter referred to as a “transmission signal”) corresponding to transmission data to each of the differential amplifier circuits 105 and 105′.

Referring to FIG. 1, the transmission circuit 106 is schematically connected with the differential amplifier circuits 105 and 105′ with a single line. However, a splitter, such as a resistive divider and a Wilkinson branching filter for dividing a high-frequency signal, may be provided in. As another method, fan-out circuits are also applicable as the differential amplifier circuits 105 and 105′.

The differential amplifier circuit 105 converts a transmission signal input from the transmission circuit 106 into a differential signal and then outputs the converted differential signal.

Thus, a positive potential signal included in the differential signal (hereinafter referred to as a “positive differential signal”) is input to the power feeding portion 102 of the transmission line 111 via a line 121 having an impedance 115 matching the impedance of the transmission line 111. On the other hand, a negative potential signal included in the differential signal (hereinafter referred to as a “negative differential signal”) is input to the power feeding portion 102 of the transmission line 112 via a line 122 having the impedance 115 matching the impedance of the transmission line 112.

The differential amplifier circuit 105′ converts the transmission signal input from the transmission circuit 106 into a differential signal and then outputs the converted differential signal.

Thus, the positive differential signal is input to a power feeding portion 102′ of a transmission line 111′ via a line 121′ having an impedance 115′ matching the impedance of the transmission line 111′. On the other hand, the negative differential signal is input to the power feeding portion 102′ of a transmission line 112′ via a line 122′ having the impedance 115′ matching the impedance of the transmission line 112′.

More specifically, the positive differential signal as a differential baseband signal is input to the power feeding portions 102 and 102′ of the transmission lines 111 and 111′ of the communication transmission lines 101 and 101′, respectively.

On the other hand, the negative differential signal as a differential baseband signal is input to the power feeding portions 102 and 102′ of the transmission lines 112 and 112′, respectively.

With the communication transmission lines 101 and 101′, the power feeding portions 102 and 102′ and the terminal portions 104 and 104′ are closely disposed facing each other in the circumferential direction so that the communication transmission lines 101 and 101′ are disposed in a substantially circular form.

More specifically, in the example illustrated in FIG. 1, the transmission lines 111 and 112 and the transmission lines 111′ and 112′ are formed in circular arc shapes each having a center angle holding the gap between their facing ends, and in shapes along circular arcs.

Each of the transmission lines 112 and 112′ of the communication transmission lines 101 and 101′, respectively, is formed in a meander shape. A meander shape is formed for correcting the influence on communication by a signal propagation delay difference caused by the signal electrical length difference due to the difference in length (wiring length) between the transmission lines 111 and 112, and the signal electrical length difference due to the difference in length between the transmission lines 111′ and 112′.

More specifically, a meander shape is characterized by the positional relationship between the transmission lines 111 and 112, the positional relationship between the transmission lines 111′ and 112′, the meander amplitude, and the meander period.

A known technique for making their wiring lengths equal to each other with meander wiring in differential transmission lines is effective in correcting a signal propagation delay difference between the lines.

To communicatively maintain at all rotational angles a coupling with a coupler 200 (described below) of a wireless communication apparatus 20 that relatively rotates about a rotation axis center 30, the power feeding portions 102 and 102′ and the terminal portions 104 and 104′ of the communication transmission lines 101 and 101′ are closely disposed.

The meander shapes of the transmission lines 112 and 112′ are determined so that the phase of the signal transmitted to the coupler 200 is contiguous while the coupler 200 is (relatively) moving from the terminal portions 104 to the terminal portions 104′ (or reversely) across the gaps between their facing ends. This also applies when the coupler 200 (relatively) moves from the power feeding portions 102 to the power feeding portions 102′ (or reversely) across their gaps.

### [Configuration of Wireless Communication Apparatus 20]

A configuration of the wireless communication apparatus 20 will be described.

The wireless communication apparatus 20 includes the coupler 200, a shaping circuit 201, and a reception circuit 202.

The coupler 200 including conductive transmission lines 211 and 212 is configured to make an electromagnetic field coupling with the communication transmission lines 101 and 101′ of the wireless communication apparatus 10.

More specifically, the transmission line 211 is disposed facing the transmission line 111 or 111′ across a gap allowing an electromagnetic field coupling in the axial direction, and the transmission line 212 is disposed facing the transmission line 112 or 112′ across a gap allowing an electromagnetic field coupling in the axial direction.

The transmission lines 211 are shorter than the transmission line 111 of the communication transmission line 101 and the transmission line 111′ of the communication transmission line 101′. The transmission lines 212 are shorter than the transmission line 112 of the communication transmission line 101 and the transmission line 112′ of the communication transmission line 101′. In addition, the transmission line 211 is formed in a circular arc shape along the shapes of the transmission lines 111 and 111′, and the transmission line 212 is formed in a circular arc shape along the shapes of the transmission lines 112 and 112′.

In the example in FIG. 1, the communication transmission lines 101 and 101′ are configured to rotate in the direction of the arrow around the rotation axis as the rotation axis center 30, and the coupler 200 is configured to relatively move around the rotation axis along the communication transmission lines 101 and 101′.

Thus, the coupler 200 contactlessly and wirelessly receives signals excited by an electromagnetic field coupling with the transmission lines 111 and 112 and the transmission lines 111′ and 112′. The received differential signals are output to the shaping circuit 201.

More specifically, the wireless communication system 1 is configured to perform wireless communication between the wireless communication apparatuses 10 and 20 through an electromagnetic field coupling.

The shaping circuit 201 has a function of amplifying the received waveform up to a voltage level detectable by the reception circuit 202 in the subsequent stage. The amplified signal is output to the reception circuit 202.

According to the first exemplary embodiment, the input impedance of the shaping circuit 201 is set, for example, to a high impedance Rrp, such as several ten kilohms. Thus, components in low-frequency bandwidths are also transmitted to the shaping circuit 201 because the input impedance Rrp is larger even in the low-frequency bandwidths than the capacitive component resulting from a coupling between the communication transmission lines 101 and 101′ and the coupler 200. Thus, the received waveform produced at the input terminal of the shaping circuit 201 is transmitted with its rectangular waveform retained.

The shaping circuit 201 may have a re-clock function through clock data recovery, in addition to the amplification function.

The reception circuit 202 performs predetermined processing based on a signal input from the shaping circuit 201.

### [Configuration of Wireless Communication System 1]

The wireless communication system 1 includes a rotating mechanism (not illustrated) with which the communication transmission lines 101 and 101′ rotate about the rotation axis as the rotation axis center 30 while the coupler 200 and the communication transmission lines 101 and 101′ maintain facing each other. In addition, the wireless communication system 1 includes a rotation control unit (not illustrated) for controlling the rotational operation of the rotating mechanism.

More specifically, the rotating mechanism may rotate only the wireless communication apparatus 10, rotate the wireless communication apparatuses 10 and 20, or rotate only the wireless communication apparatus 20 about the rotation axis.

According to the first exemplary embodiment, the rotating mechanism rotates only the wireless communication apparatus 10 about the rotation axis.

The wireless communication system 1 with the above-described configuration according to the first exemplary embodiment allows the coupler 200 to perform wireless communication through an electromagnetic field coupling while the coupler 200 relatively revolves along the communication transmission lines 101 and 101′.

### [Effects of Meander Shape]

Effects of forming the transmission lines 112 and 112′ in meander shapes will be described.

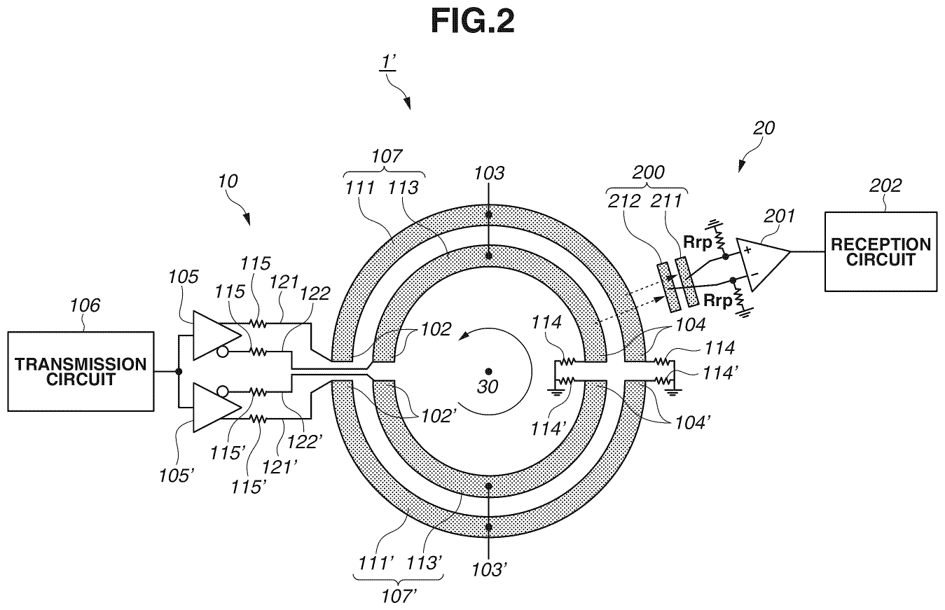

FIG. 2 illustrates a schematic configuration example of a conventional wireless communication system 1′.

As illustrated in FIG. 2, the conventional wireless communication system 1′ includes a wireless communication apparatus 10′ instead of the wireless communication apparatus 10 in the wireless communication system 1 according to the first exemplary embodiment. The wireless communication apparatus 10′ includes communication transmission lines 107 and 107′ instead of the communication transmission lines 101 and 101′ according to the first exemplary embodiment, respectively.

The communication transmission line 107 includes the transmission line 111 according to the first exemplary embodiment and a transmission line 113 having not a meander shape but the conventional shape. The communication transmission line 107′ includes the transmission line 111′ according to the first exemplary embodiment and a transmission line 113′ having not a meander shape but the conventional shape.

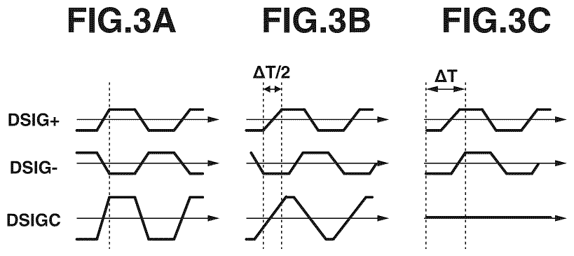

An issue arising with the transmission lines 113 and 113′ having not a meander shape but the conventional shape disposed as radially inner transmission lines will be described with reference to FIGS. 3A to 3C.

FIGS. 3A to 3C are timing charts illustrating signal waveforms at different positions on the communication transmission line 107 with the transmission line 113 having the conventional shape disposed as a radially inner transmission line. More specifically, FIG. 3A is a timing chart illustrating a signal at the positions of the power feeding portions 102 in FIG. 2, FIG. 3B is a timing chart illustrating the signal at the position of a midportion 103 in FIG. 2, and FIG. 3C is a timing chart illustrating the signal at the positions of the terminal portions 104 in FIG. 2.

In FIGS. 3A to 3C, DSIG+ indicates the positive differential signal input to the power feeding portion 102 of the transmission line 111, DSIG− indicates the negative differential signal input to the power feeding portion 102 of the transmission line 113, and DSIGC indicates the differential signal between the positive and negative differential signals (=positive differential signal-negative differential signal).

At the positions of the power feeding portions 102 illustrated in FIG. 3A, DSIG+ and DSIG− are in phase. However, a phase shift ΔT/2 and a phase shift ΔT occur at the position of the midportion 103 illustrated in FIG. 3B and the positions of the terminal portions 104 illustrated in FIG. 3C, respectively, where ΔT denotes the propagation delay difference caused by the electrical length difference between the transmission lines 111 and 113. This also occurs in the transmission line 113′.

These phase shifts change the waveform of DSIGC as illustrated in FIGS. 3B and 3C as the coupler 200 approaches the terminal portions 104. It is easily presumed that these phase shifts will be remarkable with increased speeds of the differential signal. Although FIGS. 3A to 3C illustrate a case where the amount of propagation delay ΔT matches the time length of one bit of the baseband signal for convenience of description, the present invention is not limited thereto.

Effects with the transmission lines 112 and 112′ in meander shapes disposed as radially inner transmission lines will be described with reference to FIG. 4A to 4C.

FIGS. 4A to 4C are timing charts illustrating signal waveforms at different positions on the communication transmission line 101 including the transmission line 112 having a meander shape as the radially inner transmission line. The transmission line 112′ has the same effect as the transmission line 112, and a redundant description thereof will be omitted.

More specifically, FIG. 4A is a timing chart illustrating a signal at the positions of the power feeding portions 102 in FIG. 1, FIG. 4B is a timing chart illustrating the signal at the position of a midportion 103 in FIG. 1, and FIG. 4C is a timing chart illustrating the signal at the positions of the terminal portions 104 in FIG. 1.

In FIGS. 4A to 4C, DSIG+ indicates the positive differential signal input to the power feeding portion 102 of the transmission line 111, DSIG− indicates the negative differential signal input to the power feeding portion 102 of the transmission line 112, and DSIGC indicates the differential signal between the positive and the negative differential signals (=positive differential signal-negative differential signal).

The phase shifts that occur in the conventional configuration are corrected at all the positions, the positions of the power feeding portions 102 in FIG. 4A, the position of the midportion 103 in FIG. 4B, and the positions of the terminal portions 104 in FIG. 4C. This enables theoretically high-speed communication in comparison with the conventional configuration.

The meander structure of the transmission lines 112 and 112′ is effective in correcting the propagation delay difference simply by forming a part of these transmission lines in a meander shape to make the path lengths (electrical length) equal in the transmission lines 111 and 111′. However, the configuration according to the first exemplary embodiment in which the transmission lines 211 and 212 of the coupler 200 move along the transmission line 112 and 112′ of the communication transmission lines 101 and 101′, respectively, involves correcting the propagation delay to a similar degree after the coupler 200 moves to any position. In this case, desirably, the transmission lines 112 and 112′ to make an electromagnetic field coupling with the transmission lines 211 and 212, respectively, are entirely formed in a meander shape.

### [Confirming Effects by Simulation]

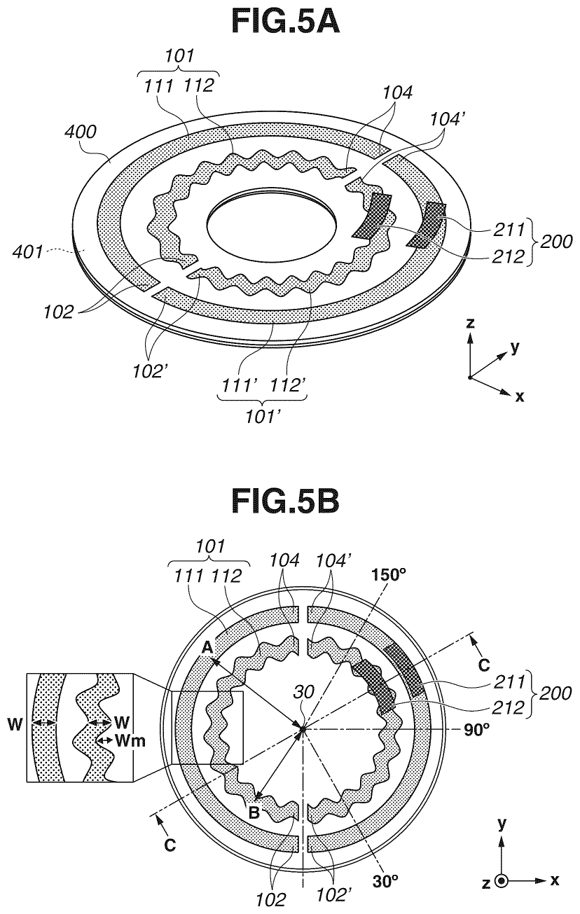

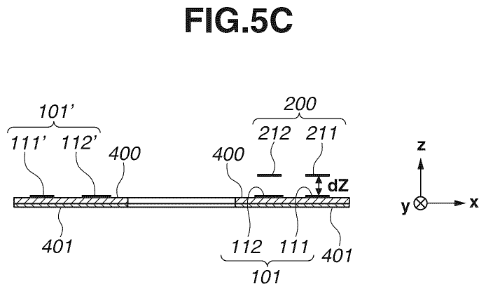

FIG. 5A is a perspective view illustrating specific structural examples of the communication transmission lines 101 and 101′ and the coupler 200. FIG. 5B is a plan view illustrating specific structural examples of the communication transmission lines 101 and 101′ and the coupler 200. FIG. 5C is a cross-sectional view taken along the C-C line of FIG. 5B. The components that have been described above with reference to FIGS. 1 and 2 are assigned the same reference numerals.

As illustrated in FIGS. 5A to 5C, the communication transmission lines 101 and 101′ are formed as copper patterns on the dielectric substrate 400. The coupler 200 is disposed apart from the upper surfaces of the communication transmission lines 101 and 101′ by a predetermined distance dZ in the Z direction (axial direction). More specifically, the distance dZ indicates the transmission distance between the transmission line 211 and the communication transmission lines 101 and 101′, and the transmission distance between the transmission line 212 and the communication transmission lines 101 and 101′.

The communication transmission lines 101 and 101′ are formed with microstrip lines. The surfaces of the communication transmission lines 101 and 101′ opposite to the line pattern forming surfaces are provided with a ground pattern 401 made of a conductor. The ground pattern 401 is a ground as the reference potential of the communication transmission lines 101 and 101′.

The communication transmission lines 101 and 101′ are not limited to microstrip lines but can be formed with coplanar lines or grounded coplanar lines.

The dielectric substrate 400 has a circular hole formed at its center, into which a rotation shaft or a shaft-shaped slip ring used for power transmission/low-speed communication applications is inserted.

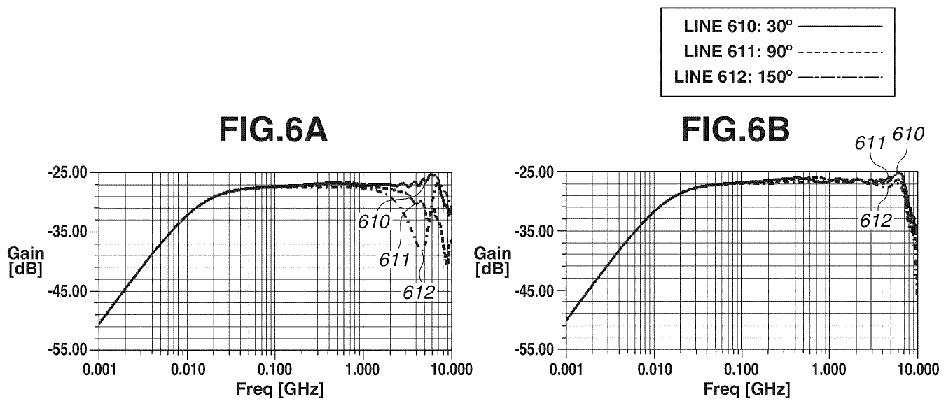

FIGS. 6A and 6B illustrate results of simulating the signal transfer characteristics (Scattering(S) parameter, Sdd21) from the power feeding portions 102 of the communication transmission line 101 to the coupler 200 in the structure illustrated in FIGS. 5A to 5C. In FIGS. 6A and 6B, the horizontal axis represents frequencies, and the vertical axis represents gains. Sdd21 denotes the insertion loss of the differential mode.

FIG. 6A illustrates the transfer characteristic with the transmission line 113 having the conventional shape. FIG. 6B illustrates the transfer characteristic with the transmission line 112 having a meander shape.

FIGS. 6A and 6B illustrate the transfer characteristics when the coupler 200 relatively moves to the positions of angles of 30, 90, and 150 degrees illustrated in FIG. 4B. In FIGS. 6A and 6B, a solid line 610 denotes the transfer characteristics at an angle of 30 degrees, a broken line 611 denotes the transfer characteristics at an angle of 90 degrees, and a dot-dash line 612 denotes the transfer characteristics at an angle of 150 degrees.

The parameters used in the simulation are shown in Table 1.

TABLE 1

| | Numerical | |
|---|---|---|
| | value | |
| Parameter | [unit] | |
| Inner diameter A of center lines of transmission | 50 | [mm] |
| lines 111 and 111′ | | |
| Inner diameter B of center lines of transmission | 40 | [mm] |
| lines 112 and 112′ | | |
| Wiring width W | 4 | [mm] |
| Meander width Wm of transmission | 2.5 | [mm] |
| lines 112 and 112′ | | |
| Number N of meander of transmission | 120 | |
| lines 112 and 112′ | | |
| Transmission distance dZ | 1.0 | [mm] |
| Thickness of dielectric substrate | 3.2 | [mm] |
| Differential impedance of communication | 100 | [Ω] |
| transmission lines 100 and 101′ | | |
| Differential impedance of power feeding | 100 | [Ω] |
| portions 102 and 102′ | | |
| Differential impedance of terminal | 100 | [Ω] |
| portions 104 and 104′ | | |
| Differential impedance of coupler 200 | 22 | [Ω] |
| Characteristic impedance of transmission | 50 | [Ω] |
| lines 111 and 111′ | | |
| Characteristic impedance of transmission | 50 | [Ω] |
| lines 112 and 112′ | | |

As illustrated in Table 1, the differential impedance is set to 100 ohms for the communication transmission lines 101 and 101′. The characteristic impedance is set to 50 ohms for the transmission lines 111 and 111′ and the transmission lines 112 and 112′.

The differential impedance is also set to 100 ohms for the communication transmission lines 107 and 107′, and the characteristic impedance is also set to 50 ohms for the transmission lines 111 and 111′ and the transmission lines 113 and 113′.

As indicated by the solid line 610 in FIG. 6A, the transmission line 113 with the conventional configuration has a substantially flat transfer characteristic up to around 5 GHz when the coupler 200 is positioned at an angle of 30 degrees, i.e., a position close to the power feeding portions 102. As indicated by the broken line 611 and the dot-dash line 612 in FIG. 6A, the gain of a frequency of 1 GHz or higher rapidly attenuates as the coupler 200 approaches the terminal portions 104 via the positions of angles of 90 and 150 degrees. For example, at the position of an angle of 150 degrees, the difference in gain between frequencies of 1 GHz and 5 GHz increases to as large as 10 dB. This also occurs in the transmission line 113′.

As indicated by the solid line 610, the broken line 611, and the dot-dash line 612 in FIG. 6B, the transmission line 112 having a meander shape maintains the substantially flat transfer characteristic at all of the positions of angles of 30, 90, and 150 degrees. For example, at the position of an angle of 150 degrees, the difference in gain between frequencies 1 GHz and 5 GHz remains around 10 dB.

The above-described results demonstrate that forming the transmission lines 112 and 112′ in a meander shape prevents the degradation of the transfer characteristic of high-frequency components.

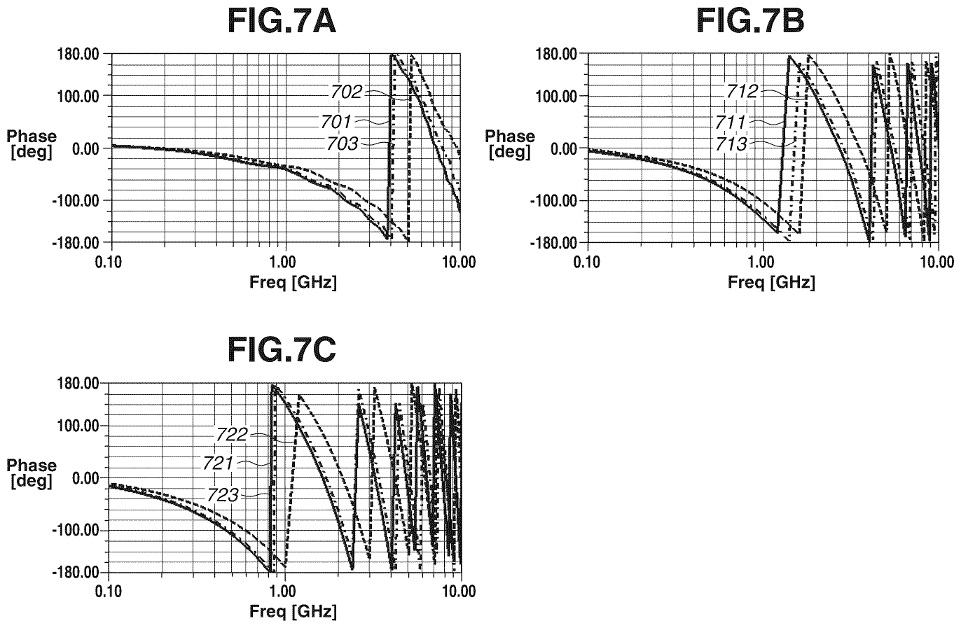

FIGS. 7A, 7B, and 7C illustrate results of simulating the phase characteristics of the signal transmitted from the power feeding portions 102 of the communication transmission line 101 to the coupler 200 in the structure illustrated in FIGS. 5A to 5C. In FIGS. 7A, 7B, and 7C, the horizontal axis represents frequencies, and the vertical axis represents phase angles. The parameters in Table 1 are also used in this simulation.

FIG. 7A illustrates the phase characteristics when the coupler 200 relatively moves to the position of an angle of 30 degrees. FIG. 7B illustrates the phase characteristics when the coupler 200 relatively moves to the position of an angle of 90 degrees. FIG. 7C illustrates the phase characteristics when the coupler 200 relatively moves to the position of an angle of 150 degrees.

In FIGS. 7A, 7B, and 7C, solid lines 701, 711 and 721 illustrate the phase characteristics of the signal transmitted from the transmission line 112 having a meander shape to the transmission line 212, respectively. Broken lines 702, 712 and 722 illustrate the phase characteristics of the signal transmitted from the transmission line 113 having the conventional shape to the transmission line 212. Dot-dash lines 703, 713, and 723 illustrate the phase characteristics of the signal transmitted from the transmission line 111 to the transmission line 211.

As indicated by the broken lines 702, 712, and 722 in FIGS. 7A, 7B, and 7C, respectively, the transmission line 113 having the conventional shape indicates a phase difference of about 40 degrees at the position of an angle of 30 degrees at a frequency of 5 GHz. In addition, the transmission line 113 indicates a phase difference of about 126 degrees at the position of an angle of 90 degrees, and a phase difference of about 205 degrees at the position of an angle of 150 degrees. More specifically, the phase difference increases as the coupler 200 approaches the terminal portions 104.

As indicated by the solid line 701, 711, and 721 in FIGS. 7A, 7B, and 7C, respectively, the transmission line 112 having a meander shape reduces the phase difference to about 9 degrees at the position of an angle of 30 degrees at a frequency of 5 GHz. In addition, the transmission line 112 reduces the phase difference to about 34 degrees at the position of an angle of 90 degrees, and restricts the phase difference to about 52 degrees at the position of an angle of 150 degrees.

The above-described results demonstrate that the transmission line 112 formed in a meander shape enables a reduction of the phase difference over the entire communication transmission line 101. This also applies to the communication transmission line 101′.

### [Design of Meander Shape]

Design of the meander shape of the transmission lines 112 and 112′ will be described.

The following describes the design of the transmission line 112. The design of the meander shape is the same as that of the transmission lines 112 and 112′.

An example will be described where the transmission line 111 has an inner diameter A of 50 mm, a wiring width of 4 mm, and an operation center frequency of 5 GHz.

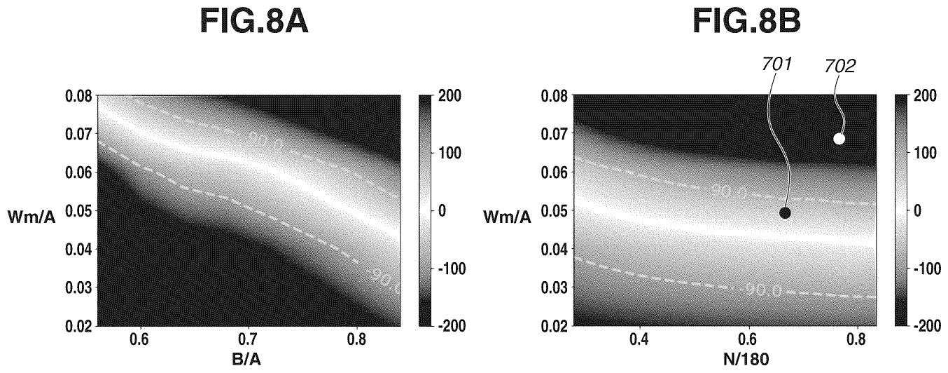

FIG. 8A illustrates the phase difference between a signal transmitted from the transmission line 111 to the transmission line 211 and a signal transmitted from the transmission line 112 to the transmission line 212 with respect to the ratio of an inner diameter B of the transmission line 112 to an inner diameter A of the transmission line 111 and the ratio of a meander width Wm of the transmission line 112 to the inner diameter A.

In FIG. 8A, the inner diameter A is the direct distance between the rotation axis center 30 and the center line passing through the widthwise center of the transmission line 111, and the inner diameter B is the direct distance between the rotation axis center 30 and the center line passing through the widthwise center of the transmission line 112. FIG. 8A illustrates the phase difference with an operation center frequency of 5 GHz as a color map.

In FIG. 8A, design parameters of the transmission line 112 include 50 mm as the inner diameter A of the transmission line 111, 4 mm as the wiring width W, and 200 as the meander number N. The dotted lines in FIG. 8A indicate the boundary line of a phase difference of 90 degrees and the boundary line of a phase difference of −90 degrees. The inner diameter B of the transmission line 112 and the meander width Wm of the transmission line 112 are designed within such ranges that the phase difference in FIG. 8A is minimized. More specifically, the meander width Wm for minimizing the phase difference is 50 to 75% of the wiring width W within the range of the wiring width W from 3.9 to 5.5 mm on an experimental basis.

FIG. 8B illustrates the phase difference between a signal transmitted from the transmission line 111 to the transmission line 211 and a signal transmitted from the transmission line 112 to the transmission line 212 with respect to the meander number N per unit angle and the ratio of the meander width Wm to the inner diameter A when the inner diameter B is 40 mm.

FIG. 8B illustrates the phase difference with an operation center frequency of 5 GHz as a color map. In FIG. 8B, design parameters of the transmission line 112 include 50 mm as the inner diameter A of the transmission line 111, 40 mm as the inner diameter B of the transmission line 112, and 4 mm as the wiring width W. The dotted lines in FIG. 8B indicate the boundary line of a phase difference of 90 degrees and the boundary line of a phase difference of −90 degrees. The meander number N per unit angle and the meander width Wm of the transmission line 112 are designed within such ranges that the phase difference in FIG. 8B is minimized.

As described above, the meander shape of the transmission line 112 is designed in such a manner that minimizes the phase difference at the center frequency between a signal transmitted from the transmission line 111 to the transmission line 211 and a signal transmitted from the transmission line 112 to the transmission line 212. This can prevent the degradation of the transfer characteristic up to the center frequency.

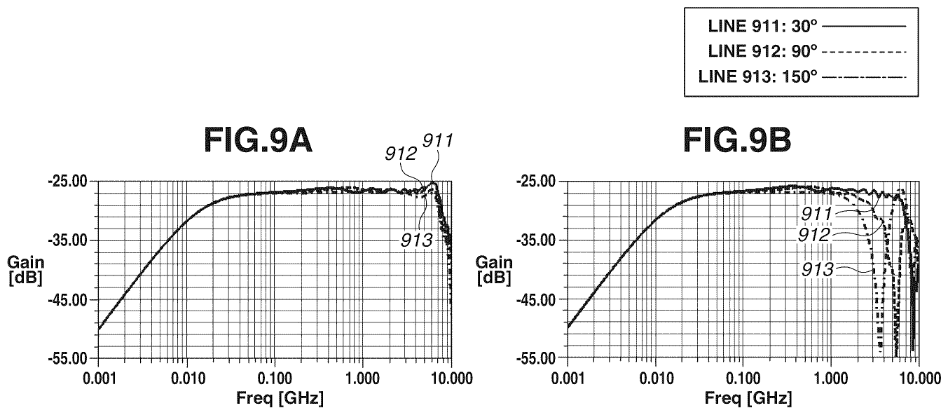

FIG. 9A illustrates results of simulating the transfer characteristic of the signal from the power feeding portions 102 of the communication transmission line 101 to the coupler 200 with design values at the position of the point 701 indicating a small phase difference in FIG. 8B. In FIG. 9A, the horizontal axis represents frequencies, and the vertical axis represents gains.

FIG. 9A illustrates the transfer characteristic when the coupler 200 moves to the positions of angles of 30, 90, and 150 degrees. In FIG. 9A, the solid line 911 indicates the transfer characteristic at an angle of 30 degrees, the broken line 912 indicates the transfer characteristic at an angle of 90 degrees, and the dot-dash line 913 indicates the transfer characteristic at an angle of 150 degrees.

Design parameters of the transmission line 112 at the point 701 in FIG. 8B includes 50 mm as the inner diameter A of the transmission line 111, 40 mm as the inner diameter B of the transmission line 112, 2.5 mm as the meander width Wm of the transmission line 112, 4 mm as the wiring width W, and 120 as the meander number N.

The meander shape designed to minimize the phase difference in this way has the transfer characteristic indicated by the solid line 911, the broken line 912, and the dot-dash line 913 in FIG. 9A. More specifically, the substantially flat transfer characteristic is maintained up to the center frequency of 5 GHz at all of the positions of angles of 30, 90, and 150 degrees.

FIG. 9B illustrates results of simulating the transfer characteristic of the signal from the power feeding portions 102 of the communication transmission line 101 to the coupler 200 with design values at the position of a point 702 indicating a large phase difference in FIG. 8B. Referring to FIG. 9B, the horizontal axis represents frequencies, and the vertical axis represents gains.

FIG. 9B illustrates the transfer characteristic when the coupler 200 moves to the positions of angles of 30, 90, and 150 degrees. In FIG. 9B, the solid line 911 indicates the transfer characteristic at an angle of 30 degrees, the broken line 912 indicates the transfer characteristic at an angle of 90 degrees, and the dot-dash line 913 indicates the transfer characteristic at an angle of 150 degrees.

Design parameters of the transmission line 112 at the point 702 in FIG. 8B includes 50 mm as the inner diameter A of the transmission line 111, 40 mm as the inner diameter B of the transmission line 112, 3.5 mm as the meander width Wm of the transmission line 112, 4 mm as the wiring width W, and 140 as the meander number N.

The meander shape designed to maximize the phase difference in this way has a substantially flat transfer characteristic up to around 5 GHz when the coupler 200 is positioned at an angle of 30 degrees, as indicated by the solid line 911 in FIG. 9B. As indicated by the broken line 912 and the dot-dash line 913 in FIG. 9B, the gain at 5 GHz frequency attenuates as the coupler 200 approaches the terminal portions 104 via the positions of angles of 90 and 150 degrees.

Based on the above-described simulation results, it is desirable to design the meander shape of the transmission line 112 in such a manner that minimizes the phase difference at the center frequency between a signal transmitted from the transmission line 111 to the transmission line 211 and a signal transmitted from the transmission line 112 to the transmission line 212. More specifically, this design can prevent the degradation of the transfer characteristic up to around the center frequency.

The wiring width W can be adjusted in such an extent that the differential and characteristic impedances remain unchanged.

While the first exemplary embodiment has been described above to be configured to set the input impedance Rrp of the shaping circuit 201 to a high impedance, such as several ten kilohms, the present invention is not limited thereto. For example, the input impedance Rrp can be set to a low impedance, such as 100 ohms.

In this case, the transfer characteristic from the communication transmission lines 101 and 101′ to the coupler 200 is similar to the characteristic of a high-pass filter (HPF) that provides a low degree of coupling in low-frequency bandwidths and a high degree of coupling in high-frequency bandwidths. Thus, only high-frequency components are transmitted in signal transmission from the communication transmission lines 101 and 101′ to the coupler 200.

More specifically, the coupler 200 generates an incomplete differentiated waveform of the signal input to the communication transmission lines 101 and 101′ (edge signals occurring at the rising and falling edges of a baseband signal input to the communication transmission lines 101 and 101′). Thus, the shaping circuit 201 is not a simple amplifier circuit but a circuit for restoring the differentiated waveform to a binary (“1” and “0”) baseband signal, such as a hysteresis comparator.

Although, in the first exemplary embodiment, the wireless communication apparatus 10 the two different communication transmission lines 101 and 101′ disposed along substantially semicircular circular arcs disposed in a substantially circular form, the present invention is not limited thereto. For example, three or more different communication transmission lines having a center angle smaller than that of the communication transmission lines 101 and 101′ can be disposed in a substantially circular form while holding gaps therebetween.

While, in first exemplary embodiment, the communication transmission lines 101 and 101′ are formed in a circular arc form about the rotation axis center 30, the present invention is not limited thereto. Other applicable configurations can be used, such as two different communication transmission lines that are formed in a semicircular circular arc form (having a center angle of 180 degrees) about the rotation axis center 30 and are disposed being mutually equally deviated from the rotation axis center 30 by the gaps therebetween, within a range where the facing state with the coupler 200 can be maintained.

While, in first exemplary embodiment, the transmission lines 111 and 112 and the transmission lines 111′ and 112′ are formed coaxially with each other in shapes along circular arcs having a common center angle, the present invention is not limited thereto. For example, when the transmission lines 112 and 112′ are formed in shapes along circular arcs shorter than those of the transmission lines 111 and 111′, the transmission lines 112 and 112′ can be formed with different center angles. More specifically, when the transmission lines 112 and 112′ have the conventional shape, these lines need to be shorter than the transmission lines 111 and 111′.

As described above, the wireless communication system 1 according to the first exemplary embodiment is configured to perform wireless communication through an electromagnetic field coupling between the wireless communication apparatus 10 as the transmitter and the wireless communication apparatus 20 as the receiver. In addition, the communication transmission lines 101 and 101′ of the wireless communication apparatus 10 are formed of differential transmission lines, and the transmission lines 111 and 111′ thereof are disposed in a circular arc form having a center angle, as substantially semicircular circular arcs. Further, the transmission lines 112 and 112′ are disposed radially inside the transmission lines 111 and 111′ and coaxially with the transmission lines 111 and 111′, respectively, in shapes along circular arcs having a common center angle. The transmission lines 112 and 112′ are formed in a meander shape that corrects a signal propagation delay difference caused by the electrical length difference due to the difference in length from the transmission lines 111 and 111′, respectively.

This configuration allows correcting a differential signal propagation delay difference between the transmission lines in each pair, providing a wireless communication system allowing wirelessly communication using differential signals at high speeds as compared with a configuration where the transmission lines 112 and 112′ are formed in the conventional shape. This configuration also allows correcting the transmission delay difference simply with the transmission lines 112 and 112′ formed in a meander shape without additional circuit components for correction, facilitating reduction in height and size of the wireless communication apparatus 10.

The communication transmission lines 101 and 101′ are formed in shapes along circular arcs about the rotation axis center 30, making it easy to apply the wireless communication system 1 according to the first exemplary embodiment to rotatable portions.

In the wireless communication system 1 according to the first exemplary embodiment, the communication transmission lines 101 and 101′ are formed in copper wiring patterns on the dielectric substrate 400. This allows reducing the height (thickness) of the wireless communication apparatus 10. In other words, the wiring patterns of the transmission lines 112 and 112′ formed in a meander shape allows correcting the transmission delay difference, making it easy to form the transmission lines on the dielectric substrate 400. This configuration eliminates the need for additional components, facilitating reduction of the height of the wireless communication apparatus 10.

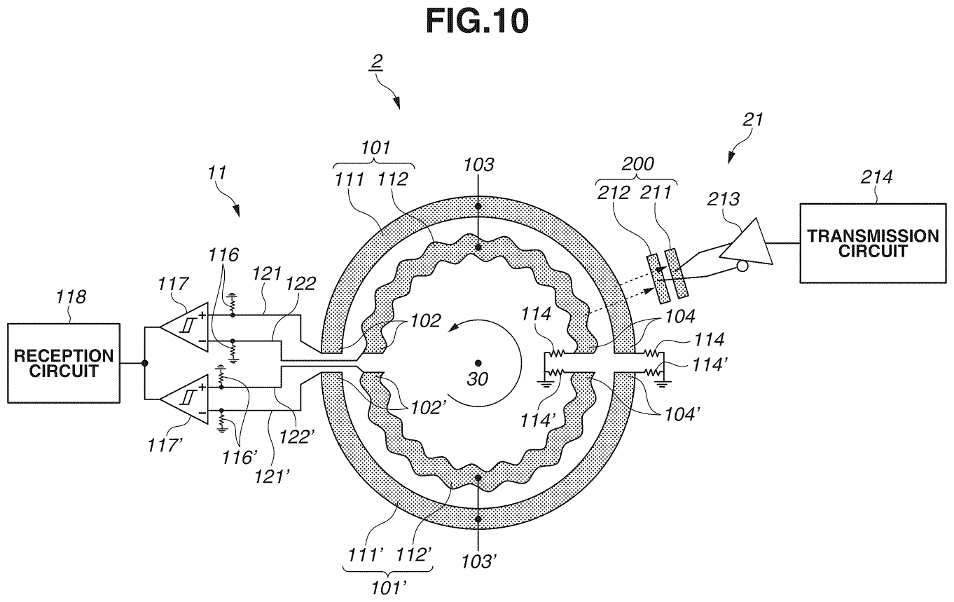

A second exemplary embodiment of the present disclosure will be described. FIG. 10 illustrates the second exemplary embodiment.

The second exemplary embodiment differs from the first exemplary embodiment in that signals are transmitted from the coupler 200 to the communication transmission lines 101 and 101′.

Components similar to those according to the first exemplary embodiment are assigned the same reference numerals, and only differences from those according to the first exemplary embodiment will be described in detail.

FIG. 10 schematically illustrates a configuration example of a wireless communication system 2 according to the second exemplary embodiment.

The wireless communication system 2 includes wireless communication apparatuses 11 and 21 as illustrated in FIG. 10.

The wireless communication apparatus 11 includes the communication transmission lines 101 and 101′ formed of differential transmission lines, shaping circuits 117 and 117′, and a reception circuit 118.

The wireless communication apparatus 21 includes the coupler 200, a differential amplifier circuit 213, and a transmission circuit 214.

The communication transmission lines 101 and 101′ are disposed on the dielectric substrate 400 to reduce the height of the wireless communication apparatus 11, similarly to the above-described first exemplary embodiment. The specific structure is similar to that in FIGS. 5A to 5C.

Like the first exemplary embodiment, in the present exemplary embodiment, the wireless communication system 2 includes a rotating mechanism (not illustrated) with which the coupler 200 and the communication transmission lines 101 and 101′ relatively rotate around the rotation axis as the rotation axis center 30 while facing each other, and a rotation control unit (not illustrated).

Each component of the wireless communication apparatus 21 will be described.

The transmission circuit 214 outputs a transmission signal to the differential amplifier circuit 213.

The differential amplifier circuit 213 converts the data transmitted from the transmission circuit 214 into a differential signal and then outputs the signal to the coupler 200.

The coupler 200 has a configuration and a function similar to those according to the first exemplary embodiment, and redundant descriptions thereof will be omitted. The differential amplifier circuit 213 outputs a positive differential signal to the transmission line 211 and outputs a negative differential signal to the transmission line 212.

Each component of the wireless communication apparatus 11 will be described.

The communication transmission lines 101 and 101′ have similar configurations and functions to those according to the first exemplary embodiment, and redundant descriptions thereof will be omitted.

The shaping circuit 117 is connected to the communication transmission line 101 via the lines 121 and 122, and the shaping circuit 117′ is connected to the communication transmission line 101′ via the lines 121′ and 122′. The shaping circuits 117 and 117′ shapes the signals to be transmitted from the coupler 200 to the communication transmission lines 101 and 101′, respectively, through an electromagnetic field coupling into a signal waveform receivable by the reception circuit 118 in the subsequent stage.

According to the second exemplary embodiment, the input terminals of the shaping circuits 117 and 117′ are provided with termination resistors 116 and 116′ having an impedance substantially equal to the characteristic impedance of the communication transmission lines 101 and 101′, respectively. The lines 121 and 121′ are also formed with their characteristic impedance substantially equal to the characteristic impedance of the communication transmission lines 101 and 101′, respectively.

As a result, the transfer characteristic from the coupler 200 to the communication transmission lines 101 and 101′ is similar to the characteristic of a high-pass filter (HPF) that provides a low degree of coupling in low-frequency bandwidths and a high degree of coupling in high-frequency bandwidths. Thus, only high-frequency components are transmitted in signal transmission from the coupler 200 to the communication transmission lines 101 and 101′. More specifically, an incomplete differentiated waveform of the signal input to the coupler 200 arises in the communication transmission lines 101 and 101′. The shaping circuits 117 and 117′ according to the second exemplary embodiment are thus formed of a circuit for restoring the differentiated waveform to a binary (“1” and “0”) baseband signal, such as a hysteresis comparator.

According to the second exemplary embodiment, the transmission lines 112 and 112′ are also formed in a meander shape like the first exemplary embodiment. The transmission lines 112 and 112′ formed in a meander shape allows reducing the influence on communication caused by the propagation delay difference due to the electrical length difference (difference in wiring length) between the transmission lines 111 and 112 (or the transmission lines 111′ and 112′). The meander shape design is similar to that according to the first exemplary embodiment, and a redundant description thereof will be omitted.

As described above, the wireless communication system 2 according to the second exemplary embodiment is configured to perform wireless communication through an electromagnetic field coupling between the wireless communication apparatus 11 as the transmitter and the wireless communication apparatus 21 as the receiver. In addition, the communication transmission lines 101 and 101′ of the wireless communication apparatus 11 are formed of differential transmission lines, and the transmission lines 111 and 111′ thereof are disposed in a circular arc form having a center angle, as substantially semicircular circular arcs. Further, the transmission lines 112 and 112′ are disposed radially inside the transmission lines 111 and 111′ and coaxially with the transmission lines 111 and 111′, in shapes along circular arcs having a common center angle. Still further, the transmission lines 112 and 112′ are formed in a meander shape that corrects a signal propagation delay difference caused by the electrical length difference due to the difference in length from the transmission lines 111 and 111′, respectively.

This configuration allows correcting a differential signal propagation delay difference between the transmission lines in each pair, providing a wireless communication system allowing wirelessly communicating differential signals at high speeds as compared with a configuration where the transmission lines 112 and 112′ are formed in the conventional shape. This configuration also allows correcting the transmission delay difference simply with the transmission lines 112 and 112′ formed in a meander shape without additional circuit components for correction, facilitating reduction in height and size of the wireless communication apparatus 11.

The communication transmission lines 101 and 101′ are formed in shapes along circular arcs about the rotation axis center 30, making it easy to apply the wireless communication system 2 according to the second exemplary embodiment to rotatable portions.

In the wireless communication system 2 according to the second exemplary embodiment, the communication transmission lines 101 and 101′ are formed on the dielectric substrate 400, allowing reduction of the height (thickness) of the wireless communication apparatus 11. In other words, the wiring patterns of the transmission lines 112 and 112′ formed in a meander shape allows correcting the transmission delay difference, making it easy to form the transmission lines on the dielectric substrate 400. This configuration eliminates the need for additional components, facilitating reduction of the height of the wireless communication apparatus 11.

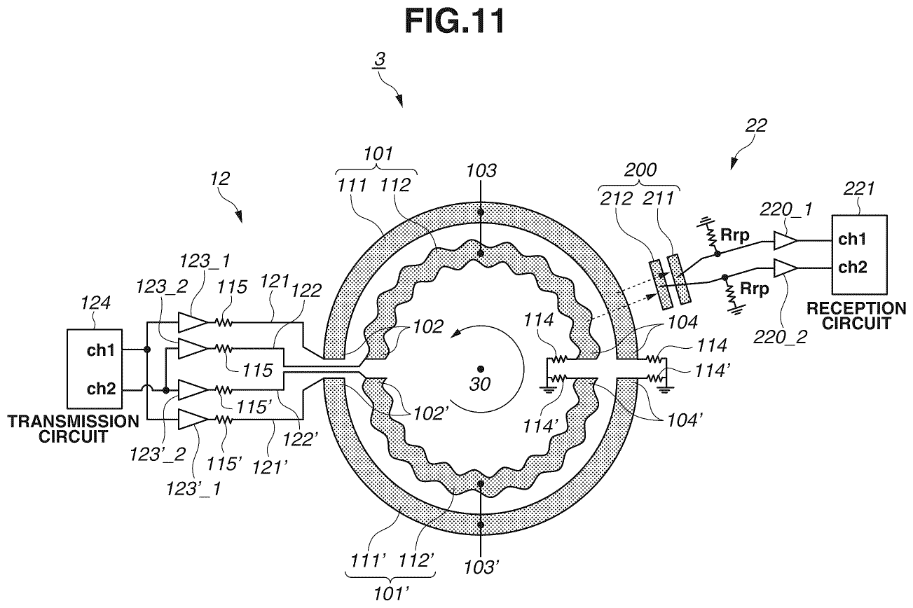

A third exemplary embodiment of the present disclosure will be described. FIG. 11 illustrates the third exemplary embodiment.

The third exemplary embodiment differs from the first exemplary embodiment in that the communication transmission lines 101 and 101′ of the wireless communication apparatus 12 transmit parallel signals to the coupler 200 of the wireless communication apparatus 20.

Components similar to those according to the first exemplary embodiment are assigned the same reference numerals, and only differences from those according to the first exemplary embodiment will be described in detail.

FIG. 11 schematically illustrates a configuration example of a wireless communication system 3 according to the third exemplary embodiment.

The wireless communication system 3 transmits two different parallel signals in parallel at the same time. In the wireless communication system 3, parallel signal transmission lines are disposed on the dielectric substrate 400. More specifically, a skew (difference in time when the signal reaches a reception circuit 221) caused by the electrical length difference due to the difference in length between transmission lines for coupling is reduced based on a concept similar to that according to the first exemplary embodiment.

The wireless communication system 3 includes wireless communication apparatus 12 and 22 as illustrated in FIG. 11.

The wireless communication apparatus 12 includes the communication transmission lines 101 and 101′, amplifier circuits 123_1 and 123_2, amplifier circuits 123′_1 and 123′_2, and a transmission circuit 124.

The wireless communication apparatus 22 includes the coupler 200, shaping circuits 220_1 and 220_2, and the reception circuit 221.

The transmission lines 111 and 111′ and the transmission lines 112 and 112′ are disposed on the same dielectric substrate to reduce the height of the wireless communication apparatus 12, like the first exemplary embodiment. The specific structure is similar to that in FIGS. 4A to 4C.

In the third exemplary embodiment, the transmission lines 211 and 212 of the coupler 200 are referred to as couplers 211 and 212, respectively, for convenience of description.

Like the first exemplary embodiment, the coupler 211 and the transmission lines 101 and 101′, and the coupler 212 and the transmission lines 112 and 112′ relatively rotate around the rotation axis as the rotation axis center 30 while facing each other. Thus, the wireless communication system 3 includes a rotating mechanism (not illustrated) and a rotation control unit (not illustrated).

Each component of the wireless communication apparatus 12 will be described.

The transmission circuit 124 includes two different output terminals CH1 and CH2 that output two different parallel signals in parallel at the same time.

The amplifier circuits 123_1 and 123′_1 amplify a data signal output from the output terminal CH1 of the transmission circuit 124 as a single-ended signal, and output the signals to the transmission lines 111 and 111′ via the lines 121 and 121′, respectively. Likewise, the amplifier circuits 123_2 and 123′_2 amplify a data signal output from the output terminal CH2 of the transmission circuit 124 as a single-ended signal, and output the signals to the transmission lines 112 and 112′ via the lines 122 and 122′, respectively. The transmission lines 111 and 111′ and the transmission lines 112 and 112′ have similar configurations and functions to those according to the first exemplary embodiment, and redundant descriptions thereof will be omitted.

Each component of the wireless communication apparatus 22 will be described.

The couplers 211 and 212 have similar configurations and functions to those of the transmission lines 211 and 212, respectively, according to the first exemplary embodiment, and redundant descriptions thereof will be omitted.

Shaping circuit 220_1 and 220_2 have similar functions to those of the shaping circuit 201 according to the above-described first exemplary embodiment. The input impedance of the shaping circuits 220_1 and 220_2 is set, for example, to a high impedance Rrp, such as several kilohms to several ten kilohms, like the first exemplary embodiment.

Thus, the input impedance Rrp is larger even in low-frequency bandwidth than the capacitive components resulting from a coupling between the communication transmission lines 111 and 111′ and the coupler 211, and a coupling between the transmission lines 112 and 112′ and the coupler 212. Thus, components in low-frequency bandwidths are also transmitted to the shaping circuits 220_1 and 220_2. As a result, receipt waveforms generated at input terminals CH1′ and CH2′ of the shaping circuits 220_1 and 220_2, respectively, are transmitted with their rectangular forms retained.

The shaping circuits 220_1 and 220_2 have functions of amplifying the receipt waveform to a voltage level detectable by the reception circuit 221 in the subsequent stage. The shaping circuits 220_1 and 220_2 can have a re-clock function through clock data recovery, as well as the amplification function.

The reception circuit 221 includes the input terminals CH1′ and CH2′ where signals output from the output terminal CH1 and CH2 are input, respectively. The input terminal CH1′ receives output signals from the shaping circuit 220_1, and the input terminal CH2′ receives output signals from the shaping circuit 220_2. The reception circuit 221 performs predetermined processing based on the signals input from the shaping circuit 201_1 and 201_2.

Also according to the third exemplary embodiment, the transmission lines 112 and 112′ are formed in a meander shape like the first exemplary embodiment. The transmission lines 112 and 112′ formed in a meander shape can prevent a skew between parallel signals due to the propagation delay difference caused by the electrical length difference due to the difference in wiring length between the transmission lines 111 and 112. As a result, a reduction of the skew allows an increase of the speed of parallel signals in comparison with the conventional configuration. The meander shape design is similar to that according to the first exemplary embodiment, and a redundant description thereof will be omitted.

As described above, the wireless communication system 3 according to the third exemplary embodiment is configured to perform wireless communication through an electromagnetic field coupling between the wireless communication apparatus 12 as the transmitter and the wireless communication apparatus 22 as the receiver. In addition, the communication transmission lines 101 and 101′ of the wireless communication apparatus 12 are formed of parallel signal transmission lines, and the transmission lines 111 and 111′ thereof are disposed in a circular arc form having a center angle, as substantially semicircular circular arcs. Further, the transmission lines 112 and 112′ are disposed radially inside the transmission lines 111 and 111′ and coaxially with the transmission lines 111 and 111′, in shapes along circular arcs having a common center angle. Still further, the transmission lines 112 and 112′ are formed in a meander shape that corrects a signal propagation delay difference caused by the electrical length difference due to the difference in length from the transmission lines 111 and 111′, respectively.

This configuration allows correcting the propagation delay difference of parallel signals between the transmission lines in each pair, providing a wireless communication system allowing wirelessly communicating parallel signals at high speeds as compared with a configuration where the transmission lines 112 and 112′ are formed in the conventional shape. This configuration also allows correcting the transmission delay difference simply with the transmission lines 112 and 112′ formed in a meander shape without additional circuit components for correction, facilitating reduction in height and size of the wireless communication apparatus 12.

The communication transmission lines 101 and 101′ are formed in shapes along circular arcs about the rotation axis center 30, making it easy to apply the wireless communication system 3 according to the third exemplary embodiment to rotatable portions.

In the wireless communication system 3 according to the third exemplary embodiment, the communication transmission lines 101 and 101′ are formed on the dielectric substrate 400, allowing reduction of the height (thickness) of the wireless communication apparatus 12. In other words, the wiring patterns of the transmission lines 112 and 112′ formed in a meander shape allows correcting the transmission delay difference, making it easy to form the transmission lines on the dielectric substrate 400. This configuration eliminates the need for additional components, facilitating reduction of the height of the wireless communication apparatus 12.

### [3-Channel Configuration]

The third exemplary embodiment has been described above centering on 2-channel parallel signal transmission. However, the present invention is not limited thereto but applicable to three or more channels. A case of 3-channel signal transmission will be described.

In 3-channel signal transmission, transmission lines are disposed in a circular arc form about the rotation axis or in shapes along circular arcs in three different lanes. The transmission line disposed in the outermost circumference is referred to as a first transmission line, the transmission line disposed in the innermost circumference is referred to as a third transmission line, and the transmission line between the first and the third transmission lines is referred to as a second transmission line. The first transmission line not formed in a meander structure is disposed in a circular arc form about the rotation axis. The second and the third transmission lines formed in a meander shape are disposed in shapes along circular arcs having a center angle common to the first transmission line about the rotation axis.

The second transmission line is formed in a meander structure for correcting the propagation delay difference from the first transmission line. The third coupling transmission line is formed in a meander structure that corrects the propagation delay difference from the first and the second transmission lines. More specifically, since the propagation delay difference to be corrected is larger with a coupling transmission line closer to the rotation axis center, the apparatus is designed to increase the meander width and meander number.

While, in the third exemplary embodiment, each parallel signal is a single-ended signal, the signal can be a differential signal. In this case, each channel is formed of two transmission lines like the communication transmission lines 101 and 101′ according to the above-described first exemplary embodiment. In this case, the design of each transmission line is similar to the design in the above-described case of 3-channel signal transmission.

In the third exemplary embodiment, the wireless communication system configured to transmit signals from the wireless communication apparatus 12 to the wireless communication apparatus 22 has been described. However, the wireless communication system can be configured to transmit signals from the wireless communication apparatus 22 to the wireless communication apparatus 12. In this case, a similar concept to the change from the configuration according to the first exemplary embodiment to the configuration according to the second exemplary embodiment is applied.

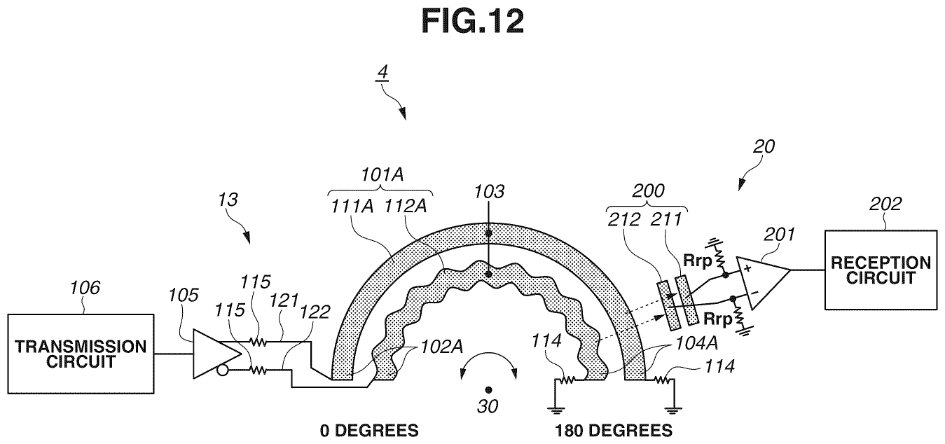

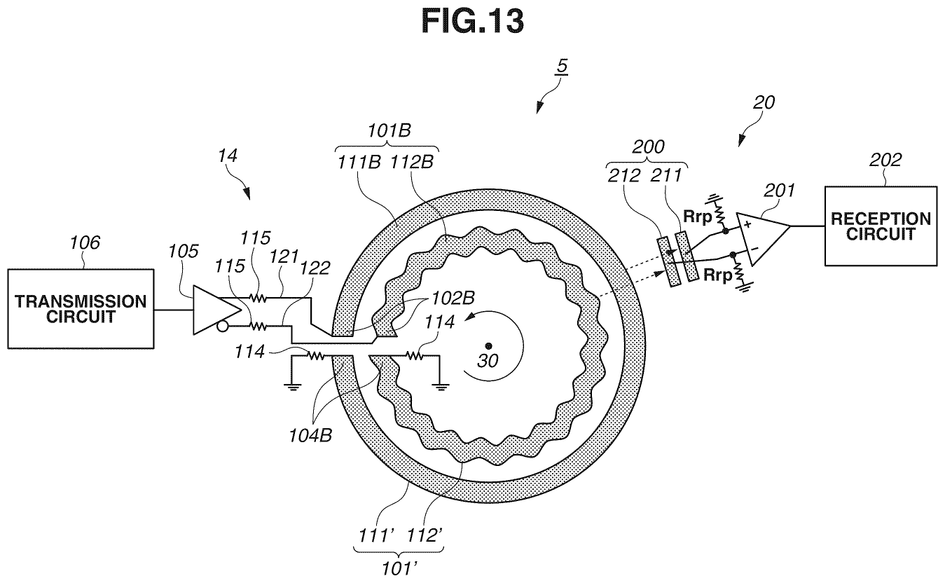

A fourth exemplary embodiment of the present disclosure will be described. FIGS. 12 and 13 illustrate the fourth exemplary embodiment.

The fourth exemplary embodiment differs from the first exemplary embodiment in that some components of the wireless communication apparatus as a transmitter are excluded.

Components similar to those according to the first exemplary embodiment are assigned the same reference numerals, and only differences from those according to the first exemplary embodiment will be described in detail.

FIG. 12 schematically illustrates a configuration example of a wireless communication system 4 according to the fourth exemplary embodiment.

The wireless communication system 4 is configured without the communication transmission line 101′, the differential amplifier circuit 105′, the lines 121′ and 122′, and the termination resistors 114′ compared with the wireless communication system 1 according to the first exemplary embodiment. In addition, the communication transmission line 101 according to the first exemplary embodiment is replaced with a communication transmission line 101A.

The communication transmission line 101A includes a transmission line 111A disposed in a semicircular circular arc form about the rotation axis center 30, and a transmission line 112A disposed radially inside the transmission line 111A and coaxially with the transmission line 111A. The two transmission lines are disposed in shapes along circular arcs having a common center angle. This configuration eliminates the need for considering the facing gaps with other communication transmission lines, allowing the transmission lines to be disposed in shapes along circular arcs having a center angle of 180 degrees.

The communication transmission line 101A is disposed on the dielectric substrate 400, for example, to reduce the height (thickness) of the wireless communication apparatus 13. More specifically, the communication transmission line 101A consists of the transmission lines 111A and 112A disposed in shapes along circular arcs having a center angle of 180 degrees without the communication transmission line 101′ on the dielectric substrate 400 in FIGS. 5A to 5C.

In the wireless communication system 4, the coupler 200 and the communication transmission line 101A are configured to relatively reciprocatably rotate about the rotation axis center 30 in an angular range from 0 to 180 degrees where those can continue facing each other. Thus, the wireless communication system 4 includes a rotating mechanism (not illustrated) and a rotation control unit (not illustrated).

A wireless communication apparatus 13 according to the fourth exemplary embodiment is suitably applicable to rotatable portions (not requiring infinite rotation) on the premise of reciprocal rotation, such as the tilting unit of pan-tilt cameras.

As described above, the wireless communication system 4 according to the fourth exemplary embodiment is configured to perform wireless communication through an electromagnetic field coupling between the wireless communication apparatus 13 as the transmitter and the wireless communication apparatus 20 as the receiver. In addition, the communication transmission line 101A of the wireless communication apparatus 13 is formed of the differential transmission lines, and the transmission line 111A thereof is disposed in a circular arc form having a center angle (180 degrees), as a semicircular circular arc. Further, the transmission line 112A is disposed radially inside the transmission line 111A and coaxially with the transmission line 111A, in a shape along a circular arc having a common center angle. Still further, the transmission line 112A is formed in a meander shape that corrects a signal propagation delay difference caused by the electrical length difference due to the difference in length from the transmission line 111A.

This configuration allows correcting a differential signal propagation delay difference between the transmission lines 111A and 112A, providing a wireless communication system allowing wirelessly communicating differential signals at high speeds as compared with a configuration where the transmission line 112A is formed in the conventional shape. This configuration also allows correcting the transmission delay difference simply with the transmission line 112A formed in a meander shape without additional circuit components for correction, facilitating reduction in height and size of the wireless communication apparatus 13.

The communication transmission line 101A is configured in a shape along a circular arc about the rotation axis center 30, making it easy to apply the wireless communication system 4 according to the fourth exemplary embodiment to rotatable portions having a rotation range from 0 to 180 degrees.

In the wireless communication system 4 according to the fourth exemplary embodiment, the communication transmission line 101A is formed on the dielectric substrate 400, allowing reduction of the height (thickness) of the wireless communication apparatus 13. In other words, the wiring pattern of the transmission line 112A formed in a meander shape allows correcting the transmission delay difference, making it easy to form the transmission lines on the dielectric substrate 400. This configuration eliminates the need for additional components, facilitating reduction of the height of the wireless communication apparatus 13.

While, in the fourth exemplary embodiment, the rotating mechanism rotates in the range from 0 to 180 degrees, the present invention is not limited thereto. An adjusted transmission line length of the communication transmission line 101A allows setting a desired angle. As a specific example, a configuration where each transmission line is disposed in a shape along a substantially circular arc will be described.

FIG. 13 schematically illustrates a configuration of a wireless communication system 5 according to a modification of the fourth exemplary embodiment.

As illustrated in FIG. 13, the wireless communication system 5 includes wireless communication apparatuses 14 and 20.

The wireless communication apparatus 14 includes a communication transmission line 101B formed of differential transmission lines, the differential amplifier circuit 105, and the transmission circuit 106.

The communication transmission line 101B is disposed on the dielectric substrate 400, for example, to reduce the height (thickness) of the wireless communication apparatus 14.

The communication transmission line 101B includes a transmission line 111B disposed in a substantially circular arc form (for example, in a circular arc form having a center angle of 350 degrees) about the rotation axis center 30. In addition, the communication transmission line 101B includes a transmission line 112B disposed radially inside the transmission line 111B and coaxially with the transmission line 111B, in a shape along a circular arc having a common center angle. The transmission lines 111B and 112B are each formed of a conductor.

One ends of the transmission lines 111B and 112B include power feeding portions 102B where signals are input from the differential amplifier circuit 105.

The other terminal portions 104B of the transmission lines 111B and 112B are terminated with respective termination resistors 114 having an impedance substantially the same as the characteristic impedance of the transmission lines 111B and 112B.

With the communication transmission line 101B, the power feeding portion 102B and the terminal portion 104B of the transmission line 111B, and the power feeding portion 102B and the terminal portion 104B of the transmission line 112B are closely disposed facing each other in the circumferential direction. The transmission line 112B of the communication transmission line 101B is formed in a meander shape.

The differential amplifier circuit 105 converts the transmission signal input from the transmission circuit 106 into a differential signal, and outputs the positive and the negative differential signals. The positive differential signal is input to the power feeding portion 102B of the transmission line 111B via the line 121 having the impedance 115 matching the impedance of the transmission line 111B. On the other hand, the negative differential signal is input to the power feeding portion 102B of the transmission line 112B via the line 122 having the impedance 115 matching the impedance of the transmission line 112B.

In the wireless communication system 5, the coupler 200 and the communication transmission line 101B relatively rotate around the rotation axis as the rotation axis center 30 while facing each other. Thus, the wireless communication system 5 includes a rotating mechanism (not illustrated) and a rotation control unit (not illustrated) like the first exemplary embodiment.

In the wireless communication system 5, the coupler 200 is configured to receive signals while relatively moving around the rotation axis in the range from 0 to 360 degrees while facing the transmission lines 111B and 112B. The coupler 200 moves from one end to the other end across the facing gaps between the power feeding portions 102B and the terminal portions 104B, resulting in a delay of a transmission signal between the one end and the other end. A correction unit for correcting this delay can be separately provided.

As described above, the wireless communication system 5 according to the modification of the fourth exemplary embodiment is configured to perform wireless communication through an electromagnetic field coupling between the wireless communication apparatus 14 as the transmitter and the wireless communication apparatus 20 as the receiver. In addition, the communication transmission line 101B of the wireless communication apparatus 14 is formed of differential transmission lines, and the transmission line 111B thereof is disposed in a circular arc form having a center angle, as a substantially semicircular circular arc. Further, the transmission line 112B is disposed radially inside the transmission lines 111B and coaxially with the transmission line 111B, in a shape along a circular arc having a common center angle.

Still further, the transmission lines 112B is formed in a meander shape that corrects a signal propagation delay difference caused by the electrical length difference due to the difference in length from the transmission line 111B.

This configuration allows correcting a differential signal propagation delay difference between the transmission lines 111B and 112B, providing a wireless communication system allowing wirelessly communicating differential signals at high speeds as compared with a configuration where the transmission line 112B is formed in the conventional shape. This configuration also allows correcting a transmission delay difference simply with the transmission line 112B formed in a meander shape without additional circuit components for correction, facilitating reduction in height and size of the wireless communication apparatus 14.

The communication transmission line 101B is configured in a shape along a circular arc about the rotation axis center 30, making it easy to apply the wireless communication system 5 according to the modification of the fourth exemplary embodiment to rotatable portions.

In the wireless communication system 5 according to the modification of the fourth exemplary embodiment, the communication transmission line 101B is formed on the dielectric substrate 400, allowing reduction of the height (thickness) of the wireless communication apparatus 14. In other words, the wiring pattern of the transmission line 112B formed in a meander shape allows correcting a transmission delay difference, making it easy to form the transmission lines on the dielectric substrate 400. This configuration eliminates the need for additional components, facilitating reduction of the height of the wireless communication apparatus 14.

### Other Exemplary Embodiments

Various embodiments of the present disclosure can be embodied, for example, as a system, an apparatus, a method, a program, or a recording medium (storage medium). More specifically, various embodiments of the present disclosure are applicable to a system composed of a plurality of apparatuses (for example, a host computer, an interface device, a web application, etc.) and to an apparatus composed of one device.

Various embodiments of the present disclosure can also be implemented by supplying a program for carrying out at least one of the functions according to the above-described exemplary embodiments to a system or apparatus via a network or storage medium, and by at least one processor in the computer of the system or apparatus reading and executing the program. Further, various embodiments of the present disclosure can also be implemented with a circuit, such as an application specific integrated circuit (ASIC), for carrying out at least one function.

The disclosure of the above-described exemplary embodiments includes the following configurations and methods:

### (Configuration 1)

A wireless communication apparatus for performing wireless communication, through an electromagnetic field coupling, with another wireless communication apparatus, the wireless communication apparatus comprising:
at least one communication transmission line including a first transmission line formed of a conductor disposed in a circular arc form, and a second transmission line formed of a conductor disposed radially inside the first transmission line and coaxially with the first transmission line, the second transmission line being formed in a shape along a circular arc shorter than the first transmission line, and
a communication unit configured to be connected to the first transmission line and the second transmission line, and to input signals to the first transmission line and the second transmission line or receive signals from the first transmission line and the second transmission line,
wherein the second transmission line is formed in a meander shape that corrects a signal propagation delay difference caused by an electrical length difference from the first transmission line.

### (Configuration 2)

The wireless communication apparatus according to configuration 1, wherein the second transmission line is disposed coaxially with the first transmission line, the second transmission line being formed in a shape along a circular arc having a center angle common to the first transmission line.

### (Configuration 3)

The wireless communication apparatus according to configuration 1 or 2, wherein to correct the propagation delay difference, the second transmission line is formed in a meander shape such that a signal phase difference caused by a difference between an electrical length from one end to another end of the first transmission line and an electrical length from one end to another end of the second transmission line is 90 degrees or less.

### (Configuration 4)

The wireless communication apparatus according to any one of configurations 1 to 3,
wherein the at least one communication transmission line is at least two communication lines including one communication line including one first transmission line and one second transmission line, and another communication line including another first transmission line and another second transmission line,
wherein the at least two communication transmission lines are disposed at predetermined intervals in circumferential directions, and
wherein the at least two communication transmission lines are circumferentially adjacent to each other such that one end of the one first transmission line and one end of the one second transmission line closely face another end of the other first transmission line and another end of the other second transmission line in a circumferential direction, respectively, or
wherein the at least two communication transmission lines are circumferentially adjacent to each other such that the one end of the one first transmission line and the one end of the one second transmission line closely face the one end of the other first transmission line and the one end of the other second transmission line in a circumferential direction, respectively, or the other end of the one first transmission line and the other end of the one second transmission line face the other end of the other first transmission line and the other end of the other second transmission line in a circumferential direction, respectively.

### (Configuration 5)

The wireless communication apparatus according to any one of configurations 1 to 4,
wherein the at least one communication transmission line or the at least two communication transmission lines further comprise(s) at least one third transmission line formed of a conductor disposed radially inside the second transmission line, or the one second transmission line or the other second transmission line, and coaxially with the second transmission line, or the one second transmission line or the other second transmission line, the at least third transmission being formed in a shape along a circular arc shorter than the second transmission line, or the one second transmission line or the other second transmission line, and
wherein the one third transmission line is formed in a meander shape that corrects a propagation delay difference caused by an electrical length difference from the first transmission line, or the one first transmission line or the other first transmission line, or the second transmission line, or the one second transmission line or the other second transmission line.

### (Configuration 6)

The wireless communication apparatus according to any one of configurations 1 to 5, wherein the at least one communication transmission line or the at least two communication transmission lines is or are each configured to have a differential impedance of 100 ohms.

### (Configuration 7)

The wireless communication apparatus according to configuration 6, wherein the first transmission line, the one first transmission line, the other first transmission line, the second transmission line, the one second transmission line, the other second transmission line, the at least one third transmission line, and the plurality of third transmission lines are each configured to have a characteristic impedance of 50 ohms.

### (Configuration 8)

The wireless communication apparatus according to any one of configurations 1 to 7, wherein the one ends and the other ends of the first transmission line, the one first transmission line, the other first transmission line, the second transmission line, the one second transmission line, the other second transmission line, the at least one third transmission line, and the plurality of third transmission lines are connected to the communication unit and termination resistors, respectively.

### (Configuration 9)

The wireless communication apparatus according to any one of configurations 1 to 8,
wherein the at least one communication transmission line or the at least two communication transmission lines include(s) one differential pair or a plurality of differential pairs including a differential pair formed of the first transmission line and the second transmission line, the one first transmission line and the one second transmission line, or the other first transmission line and the other second transmission line, and
wherein a first signal input to one of two radially adjacent transmission lines of the one differential pair or each of the plurality of differential pairs and a second signal input to the other of the radially transmission lines are differential signals in reverse phase.

### (Configuration 10)

The wireless communication apparatus according to any one of configurations 1 to 8, wherein the signals input to the first transmission line, the one first transmission line, the other first transmission line, the second transmission line, the one second transmission line, the other second transmission line, the at least third transmission line, and plurality of third transmission lines are different signals input in parallel at the same time.

### (Configuration 11)

The wireless communication apparatus according to any one of configurations 1 to 10, wherein the at least one communication transmission line or the at least two communication transmission lines is or are formed in copper patterns on a dielectric substrate.

### (Configuration 12)

The wireless communication apparatus according to any one of configurations 1 to 11, wherein a meander width as an amplitude of a meander wiring portion forming the meander shape is 50 to 75% of a width of the second transmission line, the one second transmission line, the other second transmission line, the at least one third transmission line, and each of the plurality of third transmission lines formed in a meander shape.

### (Configuration 13)

A wireless communication system comprising:
a first wireless communication apparatus as the wireless communication apparatus according to any one of configurations 1 to 12,
a second communication transmission line including a plurality of transmission lines facing transmission line surfaces of the first transmission line and the second transmission line of a first communication transmission line as the at least one communication transmission line of the first wireless communication apparatus, across predetermined intervals, and
a second wireless communication apparatus including a second communication unit connected to the plurality of the transmission lines, and configured to input signals to the plurality of the transmission lines and receive signals from the plurality of the transmission lines.

### (Configuration 14)

The wireless communication system according to configuration 13, the wireless communication system further comprising a moving unit configured to move at least one of the first communication transmission line and the second communication transmission line along the other one of the first communication transmission line and the second communication transmission line in a state where a facing state of the transmission line surfaces is maintained, and move the at least one of the first communication transmission line and the second communication transmission line around a rotation axis,
wherein the first transmission line and the second transmission line of the first communication transmission line and the plurality of transmission lines of the second communication transmission line are each disposed in a circular arc form about a center of the rotation axis or in a shape along a circular arc.

### (Method 1)

A method for controlling a wireless communication apparatus comprising a communication transmission line including a first transmission line formed of a conductor disposed in a circular arc form, and a second transmission line formed of a conductor disposed radially inside the first transmission line and coaxially with the first transmission line, the second transmission line being formed in a shape along a circular arc shorter than the first transmission line, and a communication unit connected to the first transmission line and the second transmission line and configured to communicate with the first transmission line and the second transmission line, the second transmission line being formed in a meander shape that corrects a signal propagation delay difference caused by an electrical length difference from the first transmission line, the method comprising communicating by the communication unit inputting signals to the first transmission line and the second transmission line or receiving signals from the first transmission line and the second transmission line.

### (Method 2)

A method for controlling a wireless communication system comprising a first wireless communication apparatus as the wireless communication apparatus according to any one of configurations 1 to 11, a second communication transmission line including a plurality of transmission lines facing transmission line surfaces of the first transmission line and the second transmission line of a first communication transmission line as the at least one communication transmission line of the first wireless communication apparatus, across predetermined intervals, and a second communication unit connected to the plurality of the transmission lines and configured to communicate with the plurality of the transmission lines, the method comprising:
firstly communicating by the communication unit inputting signals to the first transmission line and the second transmission line of the first communication transmission line or receiving signals from first transmission line and the second transmission line, and
secondly communicating by the second communication unit inputting signals to the plurality of transmission lines or receiving signals from the plurality of transmission lines.

### (Configuration 15)

A program for causing a computer to function as each unit of the wireless communication apparatus according to any one of configurations 1 to 12.

### (Configuration 16)

A program for causing a computer to function as each unit of the wireless communication system according to configuration 13 or 14.

While the various exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-138935, filed Aug. 29, 2023, which is hereby incorporated by reference herein in its entirety.

What is claimed is:

1. A wireless communication apparatus for performing wireless communication, through an electromagnetic field coupling, with another wireless communication apparatus, the wireless communication apparatus comprising:
at least one communication transmission line comprising a first transmission line formed of a conductor disposed in a circular arc form, and a second transmission line formed of a conductor disposed radially inside the first transmission line and coaxially with the first transmission line, the second transmission line being in a shape along a circular arc shorter than the first transmission line; and
a communication unit configured to be connected to the first transmission line and the second transmission line and configured to transmit signals to the first transmission line and the second transmission line or receive signals from the first transmission line and the second transmission line,
wherein at least a part of the second transmission line is formed in a meander shape.

2. The wireless communication apparatus according to claim 1, wherein the second transmission line is disposed in a shape along a circular arc having a center angle common to the first transmission line.

3. The wireless communication apparatus according to claim 1, wherein to correct a propagation delay difference from the first transmission line, the second transmission line is configured such that a signal phase difference caused by a difference between an electrical length from one end to another end of the first transmission line and an electrical length from one end to another end of the second transmission line is 90 degrees or less.

4. The wireless communication apparatus according to claim 1,
wherein the at least one communication transmission line is at least two communication transmission lines including one communication line including one first transmission line and one second transmission line, and another communication line including another first transmission line and another second transmission line,
wherein the at least two communication transmission lines are disposed at predetermined intervals in circumferential directions, and
wherein the at least two communication transmission lines are circumferentially adjacent to each other such that one end of the one first transmission line and one end of the one second transmission line closely face another end of the other first transmission line and another end of the other second transmission line in a circumferential direction, respectively, or
wherein the at least two communication transmission lines are circumferentially adjacent to each other such that the one end of the one first transmission line and the one end of the one second transmission line closely face the one end of the other first transmission line and the one end of the other second transmission line in a circumferential direction, respectively, or the other end of the one first transmission line and the other end of the one second transmission line face the other end of the other first transmission line and the other end of the other second transmission line in a circumferential direction, respectively.

5. The wireless communication apparatus according to claim 1,
wherein the at least one communication transmission line comprises at least one third transmission line formed of a conductor disposed radially inside the second transmission line and coaxially with the second transmission line, the at least one third transmission line being formed in a shape along a circular arc shorter than the second transmission line, and
wherein the at least one third transmission line is formed in a meander shape that corrects a propagation delay difference from the first transmission line or the second transmission line.

6. The wireless communication apparatus according to claim 1, wherein the at least one communication transmission line is configured to have a differential impedance of 100 ohms.

7. The wireless communication apparatus according to claim 6, wherein the first transmission line and the second transmission line each have a characteristic impedance of 50 ohms.

8. The wireless communication apparatus according to claim 1, wherein one ends of the first transmission line and the second transmission line are connected to the communication unit, and other ends of the first transmission line and the second transmission line are connected to termination resistors.

9. The wireless communication apparatus according to claim 1, wherein a first signal transmitted to the first transmission line and a second signal transmitted to the second transmission line are differential signals in reverse phase.

10. The wireless communication apparatus according to claim 1, wherein a first signal transmitted to the first transmission line and a second signal transmitted to the second transmission line are different signals input in parallel at the same time.

11. The wireless communication apparatus according to claim 1, wherein the at least one communication transmission line is formed in copper patterns on a dielectric substrate.

12. The wireless communication apparatus according to claim 1, wherein a meander width as an amplitude of a meander wiring portion forming the meander shape is 50 to 75% of a width of the second transmission line.

13. A wireless communication system comprising:
a first wireless communication apparatus including at least one communication transmission line comprising a first transmission line formed of a conductor disposed in a circular arc form, and a second transmission line formed of a conductor disposed radially inside the first transmission line and coaxially with the first transmission line, the second transmission line being in a shape along a circular arc shorter than the first transmission line, and
a second wireless communication apparatus including a plurality of transmission lines facing transmission line surfaces of the first transmission line and the second transmission line, and
wherein the first wireless communication apparatus includes a communication unit configured to be connected to the first transmission line and the second transmission line and configured to transmit signals to the first transmission line and the second transmission line or receive signals from the first transmission line and the second transmission line, and
wherein the second wireless communication apparatus includes a second communication unit connected to the plurality of the plurality of transmission lines, and configured to transmit signals to the plurality of the transmission lines and receive signals from the plurality of the transmission lines.

14. The wireless communication system according to claim 13, comprising a moving unit configured to move at least one of the first communication transmission line and the second communication transmission line along another of the first communication transmission line and the second communication transmission line in a state where a facing state of the transmission line surfaces is maintained, and move the transmission line around a rotation axis,
wherein the first communication transmission line and the second communication transmission lines are each disposed in a circular arc form about a center of the rotation axis or in shapes along circular arcs.

15. A method for controlling a wireless communication apparatus comprising a communication transmission line comprising a first transmission line formed of a conductor disposed in a circular arc form, and a second transmission line formed of a conductor disposed radially inside the first transmission line and coaxially with the first transmission line, the second transmission line being formed in a shape along a circular arc shorter than the first transmission line, and a communication unit connected to the first transmission line and the second transmission line and configured to communicate with the first transmission line and the second transmission line, at least a part of the second transmission line being formed in a meander shape, the method comprising:
communicating by the communication unit inputting signals to the first transmission line and the second transmission line or receiving signals from the first transmission line and the second transmission line.

16. A wireless communication apparatus for performing wireless communication, through an electromagnetic field coupling, with another wireless communication apparatus, the wireless communication apparatus comprising:
a communication transmission line comprising a first transmission line formed of a conductor disposed in a circular arc form, and a second transmission line formed of a conductor disposed radially inside the first transmission line and coaxially with the first transmission line, the second transmission line being formed in a shape along a circular arc shorter than the first transmission line,
wherein terminal portions of the first transmission line and the second transmission line are disposed at substantially the same position in a circumferential direction, and
wherein an electrical length of the second transmission line is substantially equal to an electrical length of the first transmission line.
